(19) United States
(12) Patent Application Publication
(10) Pub. No.: US 2007/0136143 A1
(43) Pub. Date: Jun. 14, 2007

(54) Method for creating an on-line leads marketplace by automatically submitting contact information in a standard electronic format

(76) Inventors: John Sung Kim, Dublin, CA (US); Maad Abu-Ghazalah, Pacifica, CA (US)

Correspondence Address: Maad Abu-Ghazalah, P.O. Box 1219, Pacifica, CA, 94044, US

(21) Appl. No.: 11/590,477

(22) Filed: Nov. 1, 2006

Related U.S. Application Data
(63) Continuation-in-part of application No. 11/300,805, filed on Dec. 13, 2005.

(51) Int. Cl. G06Q 30/00

(52) U.S. Cl. 705/26

(57) ABSTRACT

A method is presented for creating an on-line leads marketplace by capturing contact information and transmitting it electronically to an on-line leads marketplace. Contact information from visitors to websites or registrants to Podcasts or RSS feeds is electronically submitted to an on-line leads marketplace in a standard format, where it can be processed automatically (e.g. validated and rated) and posted for sale in the appropriate category.

### RELATED CASES

This is a continuation in part from U.S. patent application Ser. No. 11/300,805 filed on Dec. 13, 2005.

### BACKGROUND OF THE INVENTION

1. Field of the Invention

The present invention relates to an improved data processing system, and, in particular, to a business practice.

2. Description of Related Art

With the increase in purchases made through the internet, on-line marketplaces have become very popular. In an on-line marketplace, sellers post items for sale on a marketplace website administered by a marketplace server, and buyers purchase the items on-line, typically in an auction format whereby the highest bidder must purchase the item at the bid price.

Although there are many on-line marketplaces, such as the one created by eBay®, these marketplaces require sellers to manually fill out a form describing the item being sold. This is a time-consuming process and is not effective for selling a large number of items.

With reference to FIG. 1, the seller starts by going to the marketplace website (step 101) and manually filling out an on-line form describing the item being offered for sale (step 102). The marketplace server then posts the description of on-line (step 103) and allows potential buyers to bid on the item (step 104). After the bidding is complete, the marketplace server provides the seller with the contact information of the highest bidder (step 105). Once the seller receives payment from the highest bidder, the seller sends the item directly to the highest bidder.

Since the items being sold are not actually submitted to the marketplace server (only the items' description is), the marketplace server has no way to evaluate the items offered for sale nor objectively rate their value. In the case of a marketplace for leads, the objective validation and rating of leads offered for sale is essential. Otherwise, potential buyers would have very limited ways in which to determine the value of the leads.

### SUMMARY OF THE INVENTION

A method is presented for creating an on-line leads marketplace by capturing contact information and transmitting it electronically to an on-line leads marketplace. Contact information from website registrants or registrants to Podcasts or RSS feeds is electronically submitted to an on-line leads marketplace in a standard format, where it can be processed automatically (e.g. validated and rated) and posted for sale in the appropriate category.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1 is a flow chart depicting the process through which an on-line marketplace is operated in the prior art.

FIG. 2 is a flow chart depicting the process through which an on-line leads marketplace is operated in the current invention.

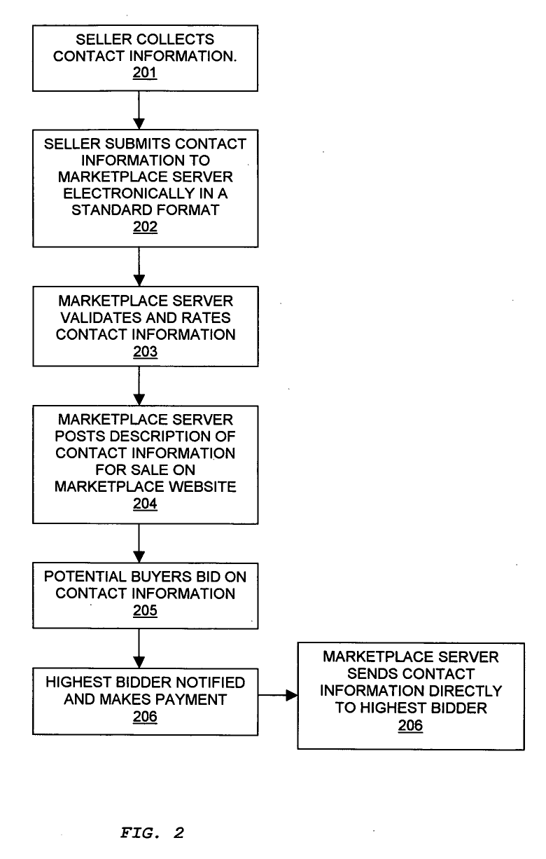

FIG. 3 is a flow chart depicting how an on-line leads marketplace can be enhanced by using profiles created by potential buyers.

### DETAILED DESCRIPTION OF THE INVENTION

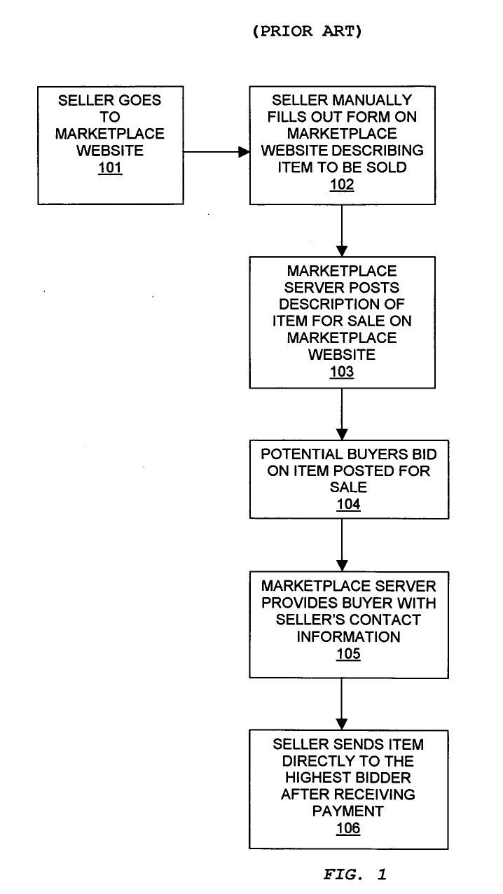

With reference to FIG. 1, a flow chart depicts the process through which an on-line leads marketplace is operated. The process begins with a lead seller collecting contact information electronically (step 201). There are many methods for obtaining the contact information include gathering information from website registrants and from registrants to Podcasts and RSS feeds. Examples of methods of obtaining website registrants include offering free tools or software, or entry into a drawing in exchange for registering by providing contact information to the website server.

In one embodiment, the contact information is collected through the use of a predictive dialer. As the predictive dialer makes and receives phone calls, it stores call log information comprising the ANI or DNIS of the caller, the time of the call, the history of the call, the duration of the call, the end result of the call, the interest level of the contact and the contact center agent recorded data of customer interaction during the call.

The lead seller then submits the contact information electronically to a marketplace server (step 202). If a predictive dialer is used to collect the contact information, the lead seller submits the call log information along with the contact information.

In one embodiment, the submission is done automatically by the lead seller whenever contact information from a threshold number of contacts has been collected. For example, the lead seller may automatically submit the contact information to the lead marketplace server as soon as information from 1,000 contacts has been collected, then subsequently, for each additional 1,000 contacts. By this method, the lead seller would be constantly submitting contact information to the lead marketplace server in groups of 1,000 contacts.

In one embodiment, the code for submitting the contact information to the marketplace server is embedded within the website, Podcast or RSS Feed by the owner of the website, Podcast or RSS Feed. In another embodiment, however, the owner of the marketplace server hosts the websites, Podcasts and RSS feeds, thereby being able to efficiently feed the contact information directly to the marketplace server. In a third embodiment, the code for submitting the contact information to the marketplace server is provided by the owner of the marketplace server to the lead seller who then embeds the code into their websites, Podcasts and RSS feeds.

The contact information submitted by the lead seller is in a standard format that can be read by the marketplace server. This allows the marketplace server to efficiently accept and process large amounts of contact information from various lead sellers automatically and without manual intervention. The submission of large amounts of contact information to the marketplace server would be extremely inefficient if the submission had to be done manually, for example by completing a form on the marketplace website for each contact's information.

Once the lead seller submits the contact information to the marketplace server, the marketplace server validates the contact information being submitted (step 203). There are various mechanisms for validating contact information, such as cross checking the information with known contact lists, sampling the validity of a portion of the contacts, determining the completeness of the information as well as its age.

As a result of the validation process, the marketplace server assigns a rating to the contact information and posts a description of the contact information along with the rating for sale in the appropriate category on the marketplace website (step 204). Validating and rating the contact information is an essential step since potential buyers would have limited means for determining the value of the contact information otherwise. Yet, the validation and rating process is only possible because the actual contact information is submitted to the marketplace server and not just a description of the items being offered for sale as is currently done in on-line marketplaces. In turn, efficiently submitting the actual contact information to the marketplace server can best be accomplished by using a standard format that is adhered to by the lead seller as opposed to the more inefficient process of entering the contact information manually into the marketplace website as is currently the practice.

Once the contact information has been rated and posted on the marketplace website, potential buyers bid to purchase the contact information (step 205). In one embodiment, buyers bid for the right to purchase the contact information exclusively. However, the lead seller may also choose to sell the contact information on a limited or non-exclusive basis.

Once the bidding is closed, the highest bidder is notified and must then make a payment in the bid amount (step 206). In one embodiment, the highest bidder makes the payment to the marketplace server which then forwards the payment to the lead seller. In another embodiment, the highest bidder makes the payment directly to the lead seller.

After the highest bidder makes the payment, the marketplace server then sends the contact information directly to the highest bidder (step 207).

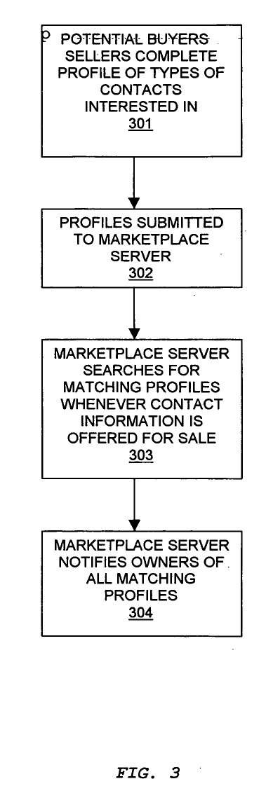

Now referring to FIG. 3, a flow chart depicts one embodiment in which potential buyers and sellers create profiles in order to be notified whenever contact information matching their profile is offered for sale on an on-line leads marketplace. This will alert potential buyers that contact information they may be interested in purchasing is being offered for sale. It will also be useful to lead sellers since the lead seller can determine the price at which the contact information was sold, which will help the lead seller estimate the price at which the lead seller can sell similar information in the future.

First, the potential buyers and potential sellers complete a profile specifying the types of contacts in which they are interested (step 301). The profile is then submitted to the marketplace server (step 302). When the marketplace server receives contact information for sale, the marketplace server compares the types of contacts being offered for sale with those specified in the potential buyer and potential seller profiles (step 303). If the type of contact information matches the type specified in the profiles, the marketplace server notifies the owners of the matching profiles, e.g. via e-mail (step 304).

A method of creating an on-line sales leads marketplace, the computer implemented method comprising:

1. A method for creating an on-line leads marketplace comprising the following steps:
A. Obtaining contact information electronically from website registrants and registrants to Podcasts or RSS feeds.
B. Electronically transmitting said contact information in a standard format to an on-line leads marketplace server.
C. Processing said contact information, including validating, rating and categorizing the contact information.
D. Offering said contact information for sale on a marketplace website, categorized and rated according to step C.

2. The method for creating an on-line leads marketplace as in claim 1 further comprising the step of accumulating the contact information until a threshold number of contacts has been obtained prior to transmitting the contact information to the on-line leads marketplace server.

3. The method for creating an on-line leads marketplace in claim 1 further comprising the step of providing a means for potential buyers and sellers to create a profile and automatically notifying the buyers and sellers whenever contact information is offered for sale that meets their profile.

4. The method for creating an on-line leads marketplace in claim 1 further including the step of hosting websites, Podcasts and RSS feeds on behalf of lead sellers in order to directly submit contact information from registrants to the marketplace server.

5. The method for creating an on-line leads marketplace in claim 1 further comprising providing code to the lead seller which is to be embedded in the lead seller's website, Podcast or RSS feed. Said code gathering contact information from website, Podcast and RSS feed registrants and automatically submitting said contact information to the marketplace server.

6. The method for creating an on-line leads marketplace in claim 1, but instead of step 1.A., contact information, including calling call log information, is collected electronically from a predictive dialer.
